(19) United States
(12) Patent Application Publication
(10) Pub. No.: US 2026/0166730 A1
(43) Pub. Date: Jun. 18, 2026

(54) Method for Estimating Robot Position Using Hierarchy-Structured Map Data

(71) Applicant: Riibotics Inc., Gyeonggi-do (KR)

(72) Inventor: Jinyong JEONG, Gyeonggi-do (KR)

(21) Appl. No.: 19/392,110

(22) Filed: Nov. 17, 2025

(30) Foreign Application Priority Data
Dec. 17, 2024 (KR) 10-2024-0188146
Dec. 17, 2024 (KR) 10-2024-0188147

(51) Int. Cl. B25J 9/16; B25J 13/08; G05D 1/243; G05D 1/246

(52) U.S. Cl. CPC B25J 9/1653; B25J 13/089; G05D 1/243; G05D 1/246

(57) ABSTRACT

A robot position estimation method, apparatus, and computer program using hierarchy-structured map data are provided. A robot position estimation method using hierarchy-structured map data according to various embodiments of the present disclosure includes generating map data for a predetermined space and estimating a position of a robot within the predetermined space based on the generated map data—the generated map data includes a plurality of map layers having different attributes and has a hierarchical structure as the plurality of map layers are connected in a hierarchical manner based on attributes.

### CROSS-REFERENCE TO RELATED PATENT APPLICATION

This application claims priority to Korean Patent Application No. 10-2024-0188146, filed Dec. 17, 2024 and Korean Patent Application No. 10-2024-0188147, filed Dec. 17, 2024, whose entire disclosures are hereby incorporated by reference.

### FIELD

Various embodiments of the present disclosure relate to a method, apparatus, and computer program for estimating and displaying the position of a robot using hierarchy-structured map data.

This invention was supported in part by the Ministry of SMEs and Startups of the Republic of Korea (Project Number: RS-2024-00507011; Project Management Agency: Korea Technology and Information Promotion Agency for SMEs (TIPA); Research Program: Startup Growth Technology Development (R&D); Research Project Title: Development of an Industrial Mobile Robot Control and Application Solution Based on Spatial Perception Using Sensor Fusion and Spatiotemporal Hierarchical Maps; Executing Organization: Robotics Co., Ltd.; Research Period: Sep. 1, 2024-Aug. 31, 2027).

### BACKGROUND

Autonomous driving technology for robots is essentially required in various industrial fields such as logistics, manufacturing, and services. In particular, position estimation of industrial robots is one of the core technologies of autonomous driving, enabling robots to recognize their accurate position in the surrounding environment, plan routes, and move toward destinations. Various methods have been proposed for this purpose, among which Grid-based position estimation is most widely utilized.

Grid-based position estimation is a method that divides space into multiple predetermined grids and represents maps based on the occupancy state of each grid. In this method, measurement values obtained from sensors (mainly LiDAR) are matched with occupancy data of the grid map, and the robot's position is estimated through the resulting score. The Grid method has advantages of being relatively simple to implement and being applicable in various environments due to its standardized spatial representation method.

However, the Grid method has several major limitations. First, the accuracy of position estimation varies according to the resolution of the grids constituting the space. As the resolution increases, the size of grids becomes smaller, enabling more accurate representation of detailed environmental information, but the number of grids increases accordingly. This causes the problem of excessively large map data size when representing wide spaces. Due to this increase in data size, computational speed becomes slower and real-time position estimation performance may deteriorate.

Conversely, if the size of grids is increased according to the scale of space, the size of map data decreases, but the problem occurs that position estimation accuracy decreases as the area that one grid can represent becomes larger. For this reason, Grid map-based position estimation has the limitation of being difficult to secure high estimation accuracy in wide spaces.

In addition, since the Grid method does not consider detailed structures of the environment, position estimation efficiency may decrease in complex environments or spaces with multi-level structures. This particularly acts as a factor that makes accurate position estimation of robots difficult in environments with wide and complex structures such as industrial sites.

In conclusion, although Grid map-based position estimation methods are widely used in industrial robots, there are difficulties in balancing between data size and position estimation accuracy. Therefore, the necessity for new methods for more efficient and accurate position estimation is emerging.

The aforementioned background technology is possessed or acquired by the inventor in the process of deriving the contents of the present disclosure, and cannot necessarily be said to be known technology disclosed to the general public before the present application.

### SUMMARY

The problem to be solved by the present disclosure is, for the purpose of resolving the aforementioned conventional problems, to generate map data having a hierarchical structure for a predetermined space and in a hierarchical manner estimate the position of a robot using a plurality of map layers included in the map data, thereby relating to a robot position estimation method, apparatus, and computer program using hierarchy-structured map data that can more accurately estimate the position of the robot.

Another problem to be solved by the present disclosure is to roughly estimate the position and pose of a robot using a low-resolution map layer among a plurality of map layers included in hierarchy-structured map data, and when it is determined that the robot has entered a region of interest, estimate the position and pose of the robot more specifically using a high-resolution map layer, thereby not only accurately estimating the position and pose of the robot, but also relating to a robot position estimation method, apparatus, and computer program using hierarchy-structured map data that can perform positioning calculations of the robot more efficiently by selectively using the high-resolution map layer only when necessary.

Another problem to be solved by the present disclosure relates to a method, apparatus, and computer program that enable more flexible and smooth transition when switching between low-resolution maps and high-resolution maps occurs.

The problems to be solved by the present disclosure are not limited to the problems mentioned above, and other problems not mentioned will be clearly understood by those skilled in the art from the description below.

To solve the aforementioned problem, a robot position estimation method using hierarchy-structured map data according to an embodiment of the present disclosure is a method performed by a computing device, comprising generating map data for a predetermined space and estimating a position of a robot within the predetermined space based on the generated map data, wherein the generated map data includes a plurality of map layers having different attributes and may have a hierarchical structure as the plurality of map layers are connected in a hierarchical manner based on attributes.

In various embodiments, the step of generating the map data may include generating one low-resolution map layer having pixels of a first size, generating a plurality of medium-resolution map layers having pixels of a second size smaller than the first size, generating one or more high-resolution map layers having pixels of a third size smaller than the second size, and generating map data having a hierarchical structure by connecting the generated one low-resolution map layer, the generated plurality of medium-resolution map layers, and the generated one or more high-resolution map layers in a hierarchical manner starting from map layers with larger resolution sizes.

In various embodiments, the step of generating the one low-resolution map layer may include acquiring a plurality of sensor data collected while the robot travels through the predetermined space and generating one low-resolution map layer based on the acquired plurality of sensor data and collection positions of each of the acquired plurality of sensor data using Simultaneous Localization and Mapping (SLAM).

In various embodiments, the step of generating the plurality of medium-resolution map layers may include generating a plurality of grids by partitioning the predetermined space into a predetermined size and generating a plurality of medium-resolution map layers corresponding to each of the generated plurality of grids based on information recorded in the generated one low-resolution map layer.

In various embodiments, the step of generating the one or more high-resolution map layers may include setting one or more regions of interest within the predetermined space, acquiring sensor data collected as the robot scans the set one or more regions of interest, and generating one or more high-resolution map layers corresponding to the set one or more regions of interest based on the acquired sensor data.

In various embodiments, the generated map data includes one low-resolution map layer and a plurality of medium-resolution map layers corresponding to the predetermined space and one or more high-resolution map layers corresponding to one or more regions of interest set within the predetermined space, and the step of estimating the position of the robot may include estimating an initial position of the robot using the one low-resolution map layer, updating the position of the robot using the plurality of medium-resolution map layers based on the estimated initial position, and when it is determined that the robot enters the one or more regions of interest based on the updated position of the robot, updating the position of the robot using the one or more high-resolution map layers.

In various embodiments, the step of updating the position of the robot using the plurality of medium-resolution map layers may include selecting two or more medium-resolution map layers included within a predetermined range around the estimated initial position from among the plurality of medium-resolution map layers and merging the selected two or more medium-resolution map layers, and updating the position of the robot using the merged two or more medium-resolution map layers.

In various embodiments, the step of merging the two or more medium-resolution map layers may include updating medium-resolution map layers included in the merged two or more medium-resolution map layers based on the updated position of the robot.

In various embodiments, the step of estimating the position of the robot may further include structuring medium-resolution map layers and high-resolution map layers included within a predetermined range around the estimated initial position based on KD-Tree.

To solve the aforementioned problem, a computing device performing a robot position estimation method using hierarchy-structured map data according to another embodiment of the present disclosure includes a processor, a network interface, memory, and a computer program loaded in the memory and executed by the processor, wherein the computer program may include an instruction for generating map data for a predetermined space and an instruction for estimating a position of a robot within the predetermined space based on the generated map data—the generated map data includes a plurality of map layers having different attributes and has a hierarchical structure as the plurality of map layers are connected in a hierarchical manner based on attributes.

To solve the aforementioned problem, a computer program according to yet another embodiment of the present disclosure may be stored in a recording medium readable by a computing device to execute a robot position estimation method using hierarchy-structured map data, the method being combined with a computing device and including generating map data for a predetermined space and estimating a position of a robot within the predetermined space based on the generated map data—the generated map data includes a plurality of map layers having different attributes and has a hierarchical structure as the plurality of map layers are connected in a hierarchical manner based on attributes.

A robot position estimation method using hierarchy-structured map data according to an embodiment of the present disclosure may be performed by a computing device and may include the following steps.

A robot position estimation method using hierarchy-structured map data according to an embodiment of the present disclosure may include generating map data for a predetermined space and estimating a position of a robot within the predetermined space based on the generated map data.

Here, the generated map data includes a plurality of map layers having different attributes and has a hierarchical structure as the plurality of map layers are connected in a hierarchical manner based on attributes, and may include at least one low-resolution map layer corresponding to the predetermined space and one or more high-resolution map layers corresponding to one or more regions of interest set within the predetermined space.

In addition, the step of estimating the position of the robot may include estimating the position of the robot using the one low-resolution map layer and when it is determined that the robot enters the one or more regions of interest based on the estimated position of the robot, updating the position of the robot using the one or more high-resolution map layers.

Here, the step of generating map data may include generating one low-resolution map layer having pixels of a first size, generating one or more high-resolution map layers having pixels of a second size smaller than the first size, and generating map data having a hierarchical structure by connecting the generated one low-resolution map layer and the generated one or more high-resolution map layers in a hierarchical manner starting from map layers with larger sizes. Here, a map layer having a larger size refers to a map layer that covers a larger area. For example, when there is a low-resolution map layer that covers an entire predetermined space and a plurality of high-resolution map layers that each cover a portion of the predetermined space, the high-resolution map layers may be hierarchically linked starting from the low-resolution map layer.

In addition, the step of generating one low-resolution map layer may include acquiring a plurality of sensor data collected while the robot travels through the predetermined space and generating one low-resolution map layer based on the acquired plurality of sensor data and collection positions of each of the acquired plurality of sensor data using Simultaneous Localization and Mapping (SLAM).

In addition, the generated map data further includes a plurality of medium-resolution map layers, and the step of estimating the position of the robot may further include, after the step of estimating the position of the robot and before the step of updating the position of the robot, updating the position of the robot using the plurality of medium-resolution map layers based on the estimated initial position.

Here, the step of generating the map data may further include generating a plurality of medium-resolution map layers having pixels of a third size, and the third size may be smaller than the first size and larger than the second size.

In addition, the step of generating the plurality of medium-resolution map layers may include generating a plurality of grids by partitioning the predetermined space into grids of a predetermined size and generating a plurality of medium-resolution map layers corresponding to each of the generated plurality of grids based on information recorded in the generated one low-resolution map layer.

Here, the step of generating the one or more high-resolution map layers may include setting one or more regions of interest within the predetermined space, acquiring sensor data collected as the robot scans the set one or more regions of interest, and generating one or more high-resolution map layers corresponding to the set one or more regions of interest based on the acquired sensor data.

In addition, the step of updating the position of the robot using the plurality of medium-resolution map layers may include selecting two or more medium-resolution map layers included within a predetermined range around the estimated initial position from among the plurality of medium-resolution map layers and merging the selected two or more medium-resolution map layers, and updating the position of the robot using the merged two or more medium-resolution map layers.

Here, the step of merging the two or more medium-resolution map layers may include updating medium-resolution map layers included in the merged two or more medium-resolution map layers based on the updated position of the robot.

In addition, the step of estimating the position of the robot may further include structuring medium-resolution map layers and high-resolution map layers included within a predetermined range around the estimated initial position based on KD-Tree (K Dimensional-Tree).

A robot position display method using hierarchy-structured map data according to an embodiment of the present disclosure may be performed by a computing device and may include the following.

The method performed by the computing device may include generating map data for a predetermined space, estimating a position of a robot within the predetermined space based on the generated map data, and displaying the position of the robot on a map according to the generated map data.

Here, the generated map data includes a plurality of map layers having different attributes and has a hierarchical structure as the plurality of map layers are connected in a hierarchical manner based on attributes, and may include at least one low-resolution map layer corresponding to the predetermined space and one or more high-resolution map layers corresponding to one or more regions of interest set within the predetermined space.

In addition, the generated map data may include a map switching pre-judgment area and a map transition area according to the robot's destination.

Here, the step of displaying the position of the robot may include, when the robot enters the map switching pre-judgment area, collecting sensor data collected by the robot while the robot moves to the map transition area after entering the map switching pre-judgment area, determining whether resolution switching of the map is possible based on the collected sensor data, and determining the resolution of the map to display after the robot enters the map transition area based on the determination of whether resolution switching of the map is possible.

Here, the switchability of the map may be determined based on the time required for processing the sensor data and the time it takes for the robot to enter the map transition area.

In addition, the switchability of the map may be determined according to the matching rate between the generated map data and the sensor data collected by the robot.

In addition, the size of the map transition area may be determined according to the type of work to be performed at the robot's destination.

Here, the step of estimating the position of the robot may include estimating the position of the robot using the one low-resolution map layer and when it is determined that the robot enters the one or more regions of interest based on the estimated position of the robot, updating the position of the robot using the one or more high-resolution map layers.

Other specific details of the present disclosure are included in the detailed description and drawings.

According to various embodiments of the present disclosure, there is an advantage that the position of a robot can be estimated more accurately by generating map data having a hierarchical structure for a predetermined space and in a hierarchical manner estimating the position of the robot using a plurality of map layers included in the map data.

In addition, there is an advantage that positioning calculations of the robot can be performed more efficiently by roughly estimating the position and pose of the robot using a low-resolution map layer among a plurality of map layers included in hierarchy-structured map data, and when it is determined that the robot has entered a region of interest, estimating the position and pose of the robot more specifically using a high-resolution map layer, thereby not only accurately estimating the position and pose of the robot, but also selectively using the high-resolution map layer only when necessary.

The effects of the present disclosure are not limited to the effects mentioned above, and other effects not mentioned will be clearly understood by those skilled in the art from the description below.

### BRIEF DESCRIPTION OF THE DRAWINGS

The following drawings attached to this specification illustrate preferred embodiments of the present disclosure, and serve to further understand the technical spirit of the present disclosure together with the detailed description of the invention, so the present disclosure should not be construed as being limited only to the matters described in such drawings.

FIG. 1 is a diagram illustrating a robot position and pose estimation system according to an embodiment of the present disclosure.

FIG. 2 is a diagram illustrating a hardware configuration of a computing device according to another embodiment of the present disclosure.

FIG. 3 is a flowchart of a robot position and pose estimation method according to another embodiment of the present disclosure.

FIG. 4 is a flowchart of a method for generating hierarchical map data in various embodiments.

FIG. 5 is a diagram exemplarily illustrating a form of generating a low-resolution map layer based on SLAM in various embodiments.

FIG. 6 is a diagram exemplarily illustrating a form of manually selecting a region of interest for high-resolution map layer selection in various embodiments.

FIG. 7 is a diagram exemplarily illustrating map data displaying a generation completion state of a high-resolution map layer in various embodiments.

FIG. 8 is a diagram exemplarily illustrating a high-resolution map layer in the form of an occupancy grid map in various embodiments.

FIG. 9 is a diagram exemplarily illustrating hierarchical map data applicable to various embodiments.

FIG. 10 is a flowchart of a robot position estimation method using hierarchical map data in various embodiments.

FIG. 11 is a diagram exemplarily illustrating KD-tree structured map data generated based on robot position in various embodiments.

FIG. 12 is a flowchart of a robot position and pose precision estimation method using low-resolution maps and high-resolution maps in various embodiments.

FIG. 13 is a diagram exemplarily illustrating a cost map generated using a high-resolution map layer in the form of an occupancy grid map in various embodiments.

FIG. 14 is a diagram for explaining a method of distinguishing pre-judgment areas and map transition areas for switching maps with different resolutions in various embodiments.

FIG. 15 is a flowchart of a method for displaying robot positions on maps with different resolutions according to conditions in various embodiments.

### DETAILED DESCRIPTION

The advantages and features of the present disclosure, and methods for achieving them, will become clear by referring to the embodiments described in detail below together with the accompanying drawings. However, the present disclosure is not limited to the embodiments disclosed below but may be implemented in various different forms, and the present embodiments are provided only to make the disclosure of the present disclosure complete and to fully inform those skilled in the art to which the present disclosure belongs of the scope of the present disclosure, and the present disclosure is defined only by the scope of the claims.

The terminology used in this specification is for describing embodiments and is not intended to limit the present disclosure. In this specification, singular forms also include plural forms unless specifically stated otherwise in the phrase. “Comprises” and/or “comprising” used in the specification do not exclude the presence or addition of one or more other components in addition to the mentioned components.

Throughout this specification, the same reference numerals refer to the same components, and “and/or” includes each and all combinations of one or more of the mentioned components. Although “first,” “second,” etc. are used to describe various components, these components are not limited by these terms, of course. These terms are used only to distinguish one component from another component. Therefore, the first component mentioned below may be a second component within the technical spirit of the present disclosure, of course.

The term “unit” or “module” used in this specification means hardware components such as software, FPGA, or ASIC, and “unit” or “module” performs certain roles. However, “unit” or “module” is not limited to software or hardware. “Unit” or “module” may be configured to be in an addressable storage medium or may be configured to reproduce one or more processors. Therefore, as an example, “unit” or “module” includes components such as software components, object-oriented software components, class components, and task components, and processes, functions, attributes, procedures, subroutines, segments of program code, drivers, firmware, microcode, circuits, data, databases, data structures, tables, arrays, and variables. The functionality provided within components and “units” or “modules” may be combined into a smaller number of components and “units” or “modules” or may be further separated into additional components and “units” or “modules.”

Spatially relative terms such as “below,” “beneath,” “lower,” “above,” “upper,” etc. may be used to easily describe the correlation between one component and other components as shown in the drawings. Spatially relative terms should be understood as terms that include different directions of components during use or operation in addition to the directions shown in the drawings. For example, when a component shown in the drawings is flipped, a component described as “below” or “beneath” another component may be placed “above” the other component. Therefore, the exemplary term “below” may include both downward and upward directions. Components may also be oriented in other directions, and accordingly, spatially relative terms may be interpreted according to orientation.

Expressions such as “first,” “second,” or “primary,” “secondary,” etc. used in this specification are used to distinguish one object from another object when referring to a plurality of objects of the same type, unless the context indicates otherwise, and do not limit the order or importance between the objects.

Expressions used in this specification such as “A, B, and C,” “A, B, or C,” “A, B, and/or C” or “at least one of A, B, and C,” “at least one of A, B, or C,” “at least one of A, B, and/or C,” “at least one selected from A, B, and C,” “at least one selected from A, B, or C,” “at least one selected from A, B, and/or C,” etc. may mean each listed item or all possible combinations of the listed items. For example, “at least one selected from A and B” may refer to all of (1) A, (2) at least one of A, (3) B, (4) at least one of B, (5) at least one of A and at least one of B, (6) at least one of A and B, (7) at least one of B and A, (8) A and B.

The expression “based on” used in this specification is used to describe one or more factors that influence the act or operation of decision or judgment described in the phrase or sentence containing the expression, and this expression does not exclude additional factors that influence the act or operation of the decision or judgment.

The expression that a certain component (e.g., a first component) is “connected” to or “coupled” to another component (e.g., a second component) used in this specification may mean not only that the certain component is directly connected or coupled to the other component, but also that it is connected or coupled through a new other component (e.g., a third component).

The expression “configured to” used in this specification may have meanings such as “set to,” “having the ability to,” “modified to,” “made to,” “capable of,” etc., depending on the context. The expression is not limited to the meaning of “specifically designed in hardware,” and for example, a processor configured to perform a specific operation may mean a general-purpose processor capable of performing that specific operation by executing software.

Unless otherwise defined, all terms (including technical and scientific terms) used in this specification may be used with meanings that can be commonly understood by those skilled in the art to which the present disclosure belongs. In addition, terms defined in commonly used dictionaries are not interpreted ideally or excessively unless explicitly specifically defined.

In this specification, a computer means all kinds of hardware devices including at least one processor, and may be understood as a meaning that encompasses software configurations operating in the hardware device according to embodiments. For example, a computer may be understood as a meaning that includes all of smartphones, tablet PCs, desktops, laptops, and user clients and applications running on each device, but is not limited thereto.

Hereinafter, embodiments of the present disclosure will be described in detail with reference to the accompanying drawings.

Each step described in this specification is described as being performed by a computer, but the subject of each step is not limited thereto, and according to embodiments, at least some of each step may be performed in different devices.

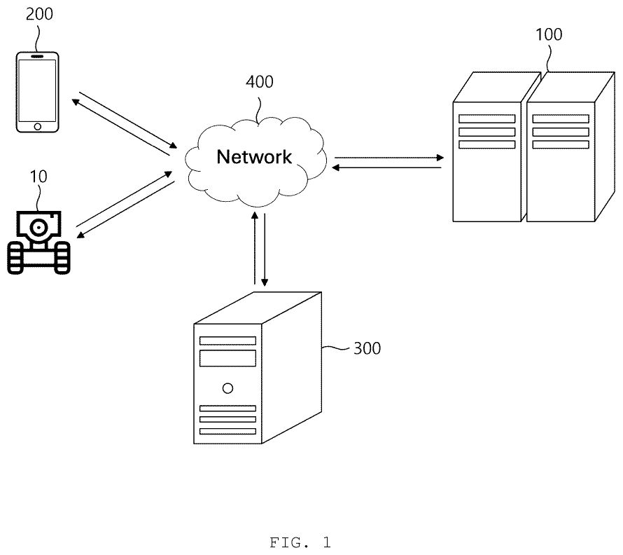

FIG. 1 is a diagram illustrating a robot position and pose estimation system according to an embodiment of the present disclosure.

Referring to FIG. 1, a robot position and pose estimation system according to an embodiment of the present disclosure may include a computing device (or a server) 100, a user terminal 200, an external server 300, and a network 400.

Here, the robot position and pose estimation system shown in FIG. 1 is according to one embodiment, and its components are not limited to the embodiment shown in FIG. 1, and may be added, changed, or deleted as necessary.

In one embodiment, the computing device 100 may perform a robot position and pose estimation process.

In various embodiments, the computing device 100 may generate map data for a predetermined space, and may estimate the position of the robot 10 within the predetermined space based on the generated map data. To this end, the computing device 100 may perform an operation of generating map data corresponding to a predetermined space and an operation of estimating the position of the robot 10 based on the map data.

Here, the generation of a map may mean loading map data previously stored in a server, or may mean generating map data according to sensor data collected from a robot. The map may be generated based on data acquired by the robot 10 as it moves through a predetermined space using sensors. The data acquired through the sensors may include image data from a camera, point-cloud data from a LiDAR sensor, Wi-Fi signals, robot speed data, GPS signals, and the like.

In addition, the computing device 100 may generate map data for a predetermined space, and may estimate the position and pose of the robot 10 within the predetermined space based on the generated map data. To this end, the computing device 100 may perform an operation of generating map data corresponding to a predetermined space and an operation of estimating the position and pose of the robot 10 based on the map data. Meanwhile, the map data may be generated by the processor of the robot and may be created inside the robot based on the sensor data acquired by the robot (camera images, LiDAR sensor data). The low-resolution and high-resolution maps generated inside the robot are synchronized with the server, and other robots may download and use the synchronized maps. A computing device may refer to a processor of the server 100 or a processor of the robot 10. For example, even though the computing device 100 is described outside of the robot in FIG. 1, it may be implemented inside the robot 10.

Here, the map data generated by the computing device 100 includes a plurality of map layers having different attributes (e.g., resolution), and may have a hierarchical structure as the plurality of map layers are connected in a hierarchical manner based on attributes.

Accordingly, the computing device 100 may estimate the position of the robot 10 more specifically and accurately in a hierarchical manner by estimating the position of the robot 10 using the plurality of map layers with different resolutions included in the hierarchical map data.

In addition, the computing device 100 roughly estimates the position and pose of the robot using a low-resolution map layer among a plurality of map layers included in the hierarchical map data, and when it is determined that the robot has entered a region of interest, estimates the position and pose of the robot more specifically using a high-resolution map layer, thereby not only accurately estimating the position and pose of the robot 10, but also performing positioning calculations of the robot 10 more efficiently by selectively using the high-resolution map layer only when necessary.

In various embodiments, the computing device 100 may be connected to the user terminal 200 through the network 400, and may provide various information and data (e.g., map data, estimated position information of the robot 10, pose information, etc.) derived by performing the robot position and pose estimation process to the user terminal 200. The network can be wireless or wired network.

Here, the user terminal 200 may mean any form of entity(s) in a system having a mechanism for communication with the computing device 100. For example, such user terminal 200 may include a personal computer (PC), a laptop, a mobile terminal, a smart phone, a tablet PC, and a wearable device, and may include all types of terminals capable of accessing wired/wireless networks. In addition, the user terminal 200 may include any computing device implemented by at least one of an agent, an Application Programming Interface (API), and a plug-in. In addition, the user terminal 200 may include an application source and/or a client application.

In addition, here, the network 400 may mean a connection structure that enables information exchange between respective nodes such as a plurality of terminals and servers. For example, the network 400 may include a Local Area Network (LAN), a Wide Area Network (WAN), the World Wide Web (WWW), wired/wireless data communication networks, telephone networks, wired/wireless television communication networks, Controller Area Network (CAN), and Ethernet.

The wireless data communication network may include, but is not limited to, 3G, 4G, 5G, 3rd Generation Partnership Project (3GPP), 5th Generation Partnership Project (5GPP), Long Term Evolution (LTE), World Interoperability for Microwave Access (WIMAX), Wi-Fi, Internet, Local Area Network (LAN), Wireless Local Area Network (Wireless LAN), Wide Area Network (WAN), Personal Area Network (PAN), Radio Frequency (RF), Bluetooth network, Near-Field Communication (NFC) network, satellite broadcasting network, analog broadcasting network, Digital Multimedia Broadcasting (DMB) network, etc.

In one embodiment, the external server 300 may be connected to the computing device 100 through the network 400, and may store and manage various information/data necessary for the computing device 100 to perform the robot position and pose estimation process.

In addition, the external server 300 may collect, store, and manage various information/data derived as the computing device 100 performs the robot position and pose estimation process.

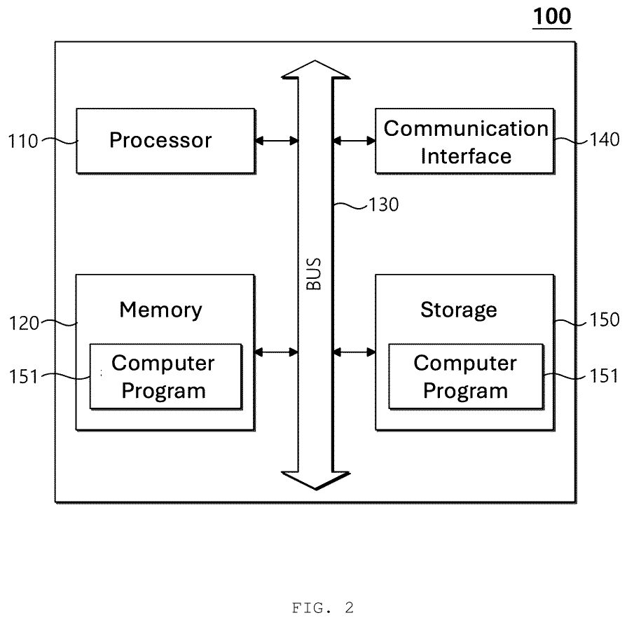

For example, the external server 300 may be a storage server separately provided outside the computing device 100, but is not limited thereto. Hereinafter, the hardware configuration of the computing device 100 will be described with reference to FIG. 2.

FIG. 2 is a diagram illustrating a hardware configuration of a computing device according to another embodiment of the present disclosure.

Referring to FIG. 2, a computing device 100 according to another embodiment of the present disclosure may include one or more processors 110, a memory 120 that loads a computer program 151 executed by the processor 110, a bus 130, a communication interface 140, and a storage 150 that stores the computer program 151. Here, FIG. 2 shows only components related to embodiments of the present disclosure. Therefore, those skilled in the art to which the present disclosure belongs can understand that other general-purpose components may be further included in addition to the components shown in FIG. 2.

The processor 110 controls the overall operation of each component of the computing device 100. The processor 110 may be configured to include a Central Processing Unit (CPU), a Micro Processor Unit (MPU), a Micro Controller Unit (MCU), a Graphic Processing Unit (GPU), or any type of processor well known in the technical field of the present disclosure.

In addition, the processor 110 may perform operations for at least one application or program for executing methods according to embodiments of the present disclosure, and the computing device 100 may include one or more processors.

In various embodiments, the processor 110 may further include Random Access Memory (RAM) (not shown) and Read-Only Memory (ROM) (not shown) that temporarily and/or permanently store signals (or data) processed inside the processor 110. In addition, the processor 110 may be implemented in the form of a System on Chip (SoC) including at least one of a graphics processing unit, RAM, and ROM.

The memory 120 stores various data, commands, and/or information. The memory 120 may load the computer program 151 from the storage 150 to execute methods/operations according to various embodiments of the present disclosure. When the computer program 151 is loaded into the memory 120, the processor 110 may perform the methods/operations by executing one or more instructions constituting the computer program 151. The memory 120 may be implemented as volatile memory such as RAM, but the technical scope of the present disclosure is not limited thereto.

The bus 130 provides communication functions between components of the computing device 100. The bus 130 may be implemented as various types of buses such as an address bus, a data bus, and a control bus.

The communication interface 140 supports wired and wireless internet communication of the computing device 100. In addition, the communication interface 140 may support various communication methods other than internet communication. To this end, the communication interface 140 may be configured to include communication modules well known in the technical field of the present disclosure. In some embodiments, the communication interface 140 may be omitted.

The storage 150 may non-temporarily store the computer program 151. When performing a robot position estimation process using hierarchical map data through the computing device 100, the storage 150 may store various information necessary to provide the robot position estimation process using hierarchical map data.

The storage 150 may be configured to include non-volatile memory such as Read Only Memory (ROM), Erasable Programmable ROM (EPROM), Electrically Erasable Programmable ROM (EEPROM), flash memory, a hard disk, a removable disk, or any type of computer-readable recording medium well known in the technical field to which the present disclosure belongs.

The computer program 151 may include one or more instructions that cause the processor 110 to perform methods/operations according to various embodiments of the present disclosure when loaded into the memory 120. That is, the processor 110 may perform the methods/operations according to various embodiments of the present disclosure by executing the one or more instructions.

In one embodiment, the computer program 151 may include one or more instructions for performing a robot position estimation method using hierarchical map data and/or a robot position and pose precision estimation method using low-resolution maps and high-resolution maps, including generating map data for a predetermined space and estimating a position of a robot within the predetermined space based on the generated map data—the generated map data includes a plurality of map layers having different attributes and has a hierarchical structure as the plurality of map layers are connected in a hierarchical manner based on attributes.

The steps of the method or algorithm described in relation to embodiments of the present disclosure may be implemented directly in hardware, as software modules executed by hardware, or by a combination thereof. Software modules may reside in Random Access Memory (RAM), Read Only Memory (ROM), Erasable Programmable ROM (EPROM), Electrically Erasable Programmable ROM (EEPROM), Flash Memory, hard disk, removable disk, CD-ROM, or any type of computer-readable recording medium well known in the technical field to which the present disclosure belongs.

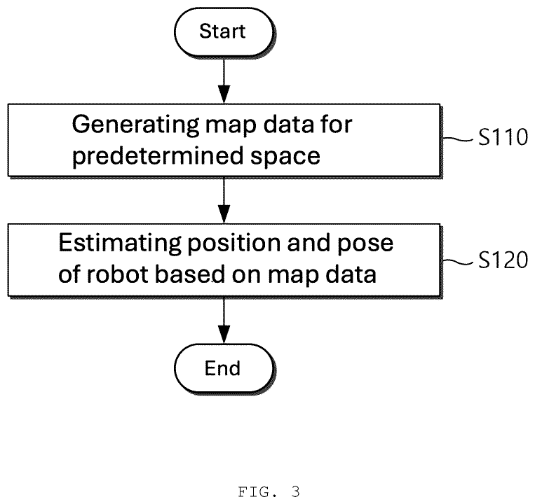

The components of the present disclosure may be implemented as a program (or application) and stored in a medium to be executed in combination with a computer, which is hardware. The components of the present disclosure may be executed as software programming or software elements, and similarly, embodiments may be implemented in programming or scripting languages such as C, C++, Java, assembler, etc., including various algorithms implemented as combinations of data structures, processes, routines, or other programming configurations. Functional aspects may be implemented as algorithms executed on one or more processors. Hereinafter, with reference to FIGS. 3 to 13, a robot position estimation method using hierarchical map data and a robot position and pose precision estimation method using low-resolution maps and high-resolution maps performed by the computing device 100 will be described.

FIG. 3 is a flowchart of a robot position and pose estimation method according to another embodiment of the present disclosure.

Referring to FIG. 3, in step S110, the computing device 100 may generate map data for a predetermined space.

In various embodiments, the computing device 100 may generate map data for a predetermined space based on sensor data collected by scanning the predetermined space.

Here, the sensor data is data collected by scanning the predetermined space through sensors provided in the robot 10 that is disposed within the predetermined space and moves through the predetermined space. For example, the sensor data may include, but is not limited to, point cloud data collected through a LiDAR sensor included in the robot 10 and image data collected through a camera sensor.

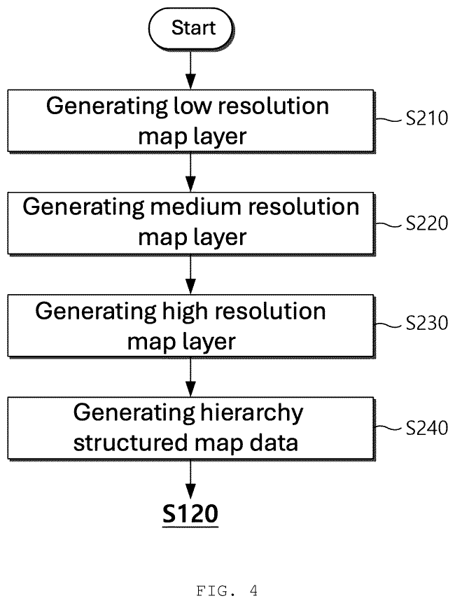

In addition, here, the map data generated by the computing device 100 includes a plurality of map layers having different attributes (e.g., resolution), and may have a hierarchical structure as the plurality of map layers are connected in a hierarchical manner based on attributes. However, it is not limited thereto. Hereinafter, a method for generating map data will be described in more detail with reference to FIG. 4.

FIG. 4 is a flowchart of a method for generating hierarchical map data in various embodiments.

Referring to FIG. 4, in step S210, the computing device 100 may generate one low-resolution map layer having pixels of a first size.

Here, the low-resolution map layer is a global map having low resolution (e.g., including pixels of 50 mm*50 mm size), which is used for position and pose initialization of the robot 10, that is, may be used to estimate the initial position and initial pose of the robot 10. In addition, the low-resolution map layer may be composed of one map including information about all areas, but is not limited thereto.

In various embodiments, the computing device 100 may generate one low-resolution map layer for a predetermined space using Simultaneous Localization and Mapping (SLAM). Here, the one low-resolution map layer may be a graph-type map layer generated based on SLAM.

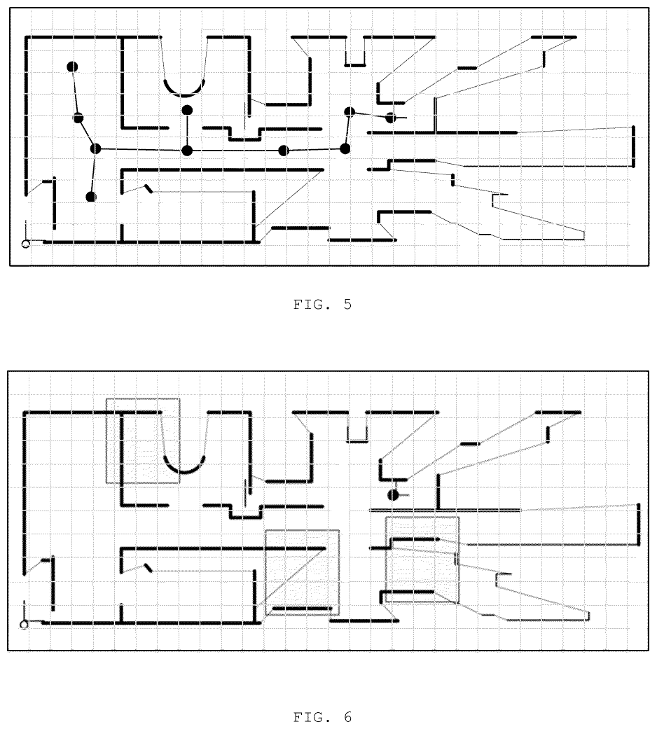

FIG. 5 is a diagram exemplarily illustrating a form of generating a low-resolution map layer based on SLAM in various embodiments.

More specifically, referring to FIG. 5, first, the computing device 100 may acquire a plurality of sensor data collected while the robot 10 travels through a predetermined space.

Thereafter, the computing device 100 may generate a plurality of nodes corresponding to collection positions of each of the plurality of sensor data, and may store information about the collection position (e.g., position coordinates) and sensor data collected at the corresponding position in each of the plurality of nodes.

Thereafter, the computing device 100 may generate edges by connecting the plurality of nodes according to the movement path of the robot 10. The edges generated in this way may include information such as movement distance, direction, and rotation values of the robot 10.

Thereafter, the computing device 100 may generate one low-resolution map layer by performing, through optimization, a process of adjusting positional relationships between nodes, a process of minimizing edge inconsistencies, and/or a loop closing process.

In step S220, the computing device 100 may generate a plurality of medium-resolution map layers having pixels of a second size smaller than the first size.

Here, the medium-resolution map layer is a map having medium resolution (e.g., including pixels of mm*10 mm size), which is generated by dividing the entire map (e.g., low-resolution map layer) into sub-maps of a predetermined size, and may be used for secondary estimation of the position of the robot 10 estimated using the low-resolution map layer.

More specifically, first, the computing device 100 may generate a plurality of grids by partitioning the predetermined space into grids of a predetermined size (e.g., 10 m*10 m).

Thereafter, the computing device 100 may generate a plurality of medium-resolution map layers corresponding to each of the plurality of grids based on information recorded in one low-resolution map layer. However, it is not limited thereto.

In step S230, the computing device 100 may generate one or more high-resolution map layers having pixels of a third size smaller than the second size.

Here, the high-resolution map layer is a map having high resolution (e.g., including pixels of 5 mm*5 mm size), which may be generated corresponding to major regions of interest (e.g., areas requiring precise position estimation for the robot 10 such as docking areas and charging areas of the robot 10). In addition, the high-resolution map layer may be used for tertiary estimation of positions estimated through medium-resolution map layers, or may be used for estimating the position and pose of the robot 10 by optimizing the initial position and initial pose estimated using the low-resolution map layer.

More specifically, first, the computing device 100 may set one or more regions of interest within a predetermined space.

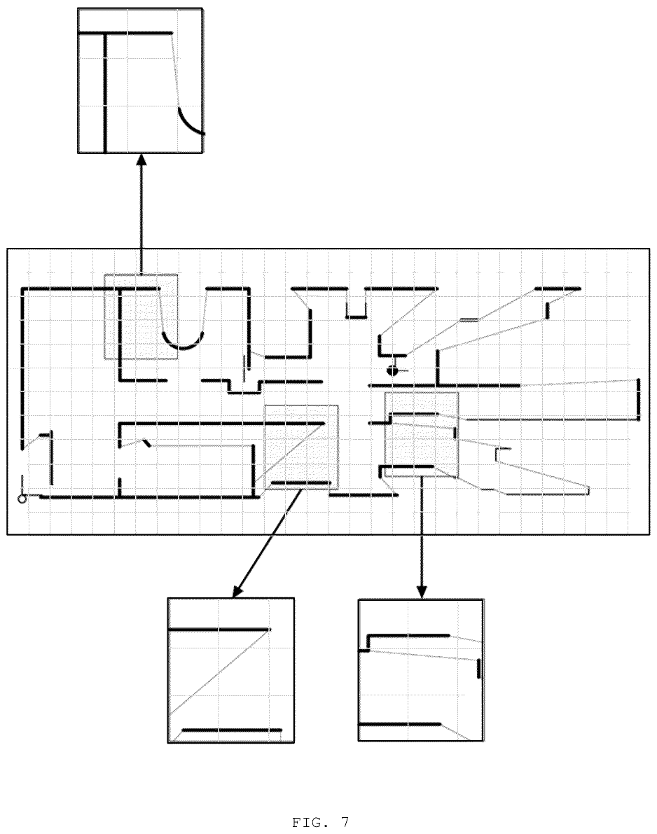

FIG. 6 is a diagram exemplarily illustrating a form of manually selecting a region of interest for high-resolution map layer selection in various embodiments.

Here, the region of interest is an area requiring precise position estimation for the robot 10 such as docking areas and charging areas of the robot 10, and as shown in FIG. 6, may be an area that provides a UI outputting a low-resolution map layer for a predetermined space to a user and is directly selected by the user through the UI, but is not limited thereto, and the region of interest may be set in various ways.

For example, the computing device 100 may set as regions of interest areas where the number of path deviations of robots 10 within a predetermined space during a predetermined period is equal to or greater than a reference deviation number, areas where the number of accident occurrences is equal to or greater than a reference accident number, or areas where the number of movements of robots 10 is equal to or greater than a reference movement number, but is not limited thereto.

Thereafter, the computing device 100 may acquire sensor data collected as the robot 10 scans one or more regions of interest. For example, when a region of interest within a predetermined space is set, the computing device 100 may generate a control command including an instruction to collect sensor data for the set region of interest and transmit it to the robot 10, and when the robot 10 collects sensor data by moving to and scanning the region of interest according to the control command acquired from the computing device 100, it may acquire this.

Thereafter, the computing device 100 may generate, as a high-resolution map layer, a high-resolution map layer corresponding to one or more regions of interest based on the sensor data.

FIG. 7 is a diagram exemplarily illustrating map data displaying a generation completion state of a high-resolution map layer in various embodiments.

When a high-resolution map layer for a region of interest is generated in this way, the computing device 100 may guide through the UI that generation of the high-resolution map layer has been completed, as shown in FIG. 7. However, it is not limited thereto.

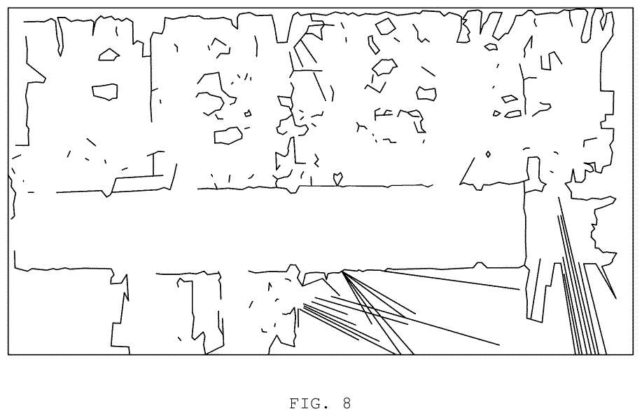

FIG. 8 is a diagram exemplarily illustrating a high-resolution map layer in the form of an occupancy grid map in various embodiments.

In various embodiments, the computing device 100 may generate a high-resolution map layer including occupancy information, that is, a high-resolution map layer in the form of an Occupancy Grid Map (e.g., FIG. 8), based on sensor data collected corresponding to the region of interest.

More specifically, first, the computing device 100 may generate a plurality of grids by gridding the space corresponding to the region of interest, and may record the state of each of the plurality of grids as occupancy information. For example, the computing device 100 may record Occupied for grids with obstacles. On the other hand, the computing device 100 may not record any particular information for grids without obstacles or without data. However, it is not limited thereto, and the computing device 100 may record Free for grids without obstacles and record Unknown for grids without data.

Thereafter, the computing device 100 may generate a high-resolution map layer by storing the plurality of grids and occupancy information recorded in each grid using a Sparse Representation method.

In step S240, the computing device 100 may generate map data having a hierarchical structure by connecting one low-resolution map layer, a plurality of medium-resolution map layers, and one or more high-resolution map layers in a hierarchical manner.

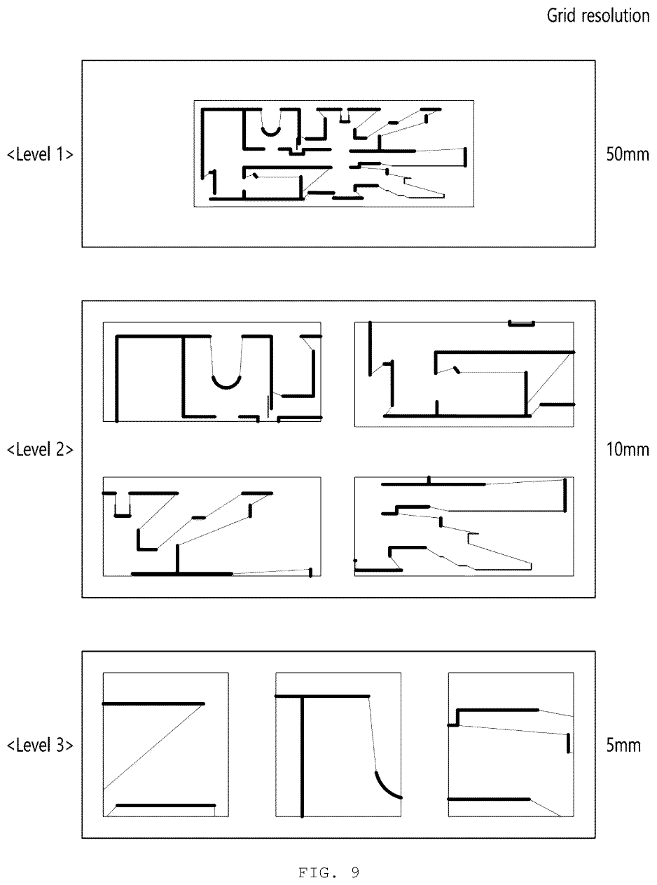

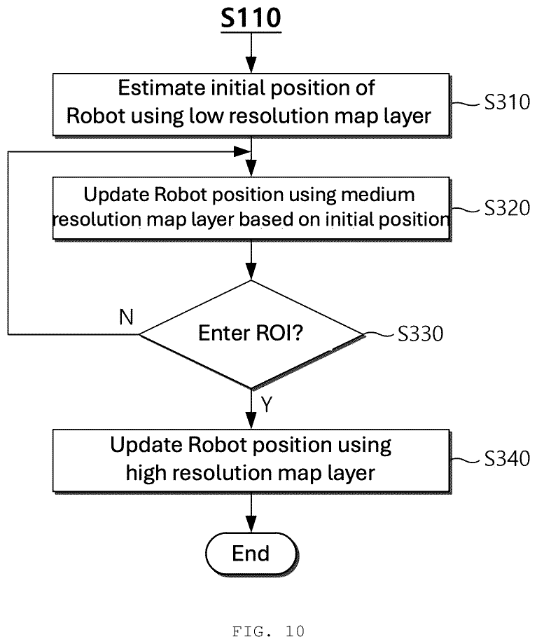

FIG. 9 is a diagram exemplarily illustrating hierarchical map data applicable to various embodiments.

In various embodiments, the computing device 100 may generate map data having a hierarchical structure by connecting one low-resolution map layer, a plurality of medium-resolution map layers, and one or more high-resolution map layers in a hierarchical manner starting from map layers with larger resolution sizes, as shown in FIG. 9.

Referring again to FIG. 3, in step S120, the computing device 100 may estimate the position and pose of the robot 10 within a predetermined space using the map data generated through step S110.

In various embodiments, the computing device 100 may estimate the position of the robot 10 or estimate the position and pose of the robot 10 using a plurality of map layers included in the hierarchical map data.

In various embodiments, the computing device 100 may update the position and pose of the robot 10 by optimizing the position and pose of the robot 10 using Equation 1 below. That is, the computing device 100 may derive the optimized position and pose of the robot 10 for updating the position and pose of the robot 10 using Equation 1 below.

$${T}^{*} = {arg max}_{T} \sum f ( {R}^{*} {m}_{i} + t ) \qquad Equation 1$$

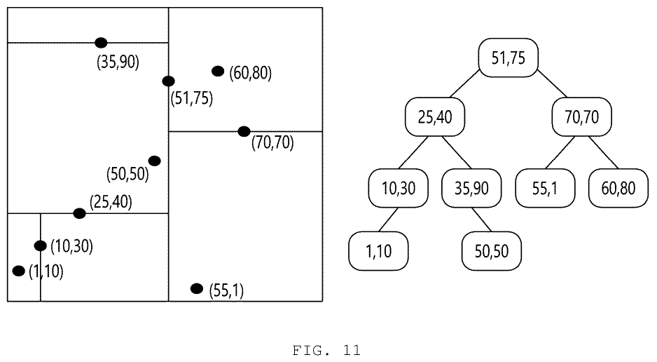

Here, T* is the optimized position and pose of the robot 10, R is the rotation transformation according to the initial pose of the robot 10, t is the translation transformation according to the initial position of the robot 10, mᵢ is a point included in the point cloud data collected from the robot 10, and ƒ( ) may be a cost calculation function according to the cost map. This will be described below with reference to FIGS. 10 to 13.

FIG. 10 is a flowchart of a robot position estimation method using hierarchical map data in various embodiments.

Referring to FIG. 10, in step S310, the computing device 100 may estimate the initial position of the robot 10 using one low-resolution map layer. For example, the computing device 100 may estimate the initial position of the robot 10 (coarse position estimation) based on sensor data collected from the robot 10 and the low-resolution map layer.

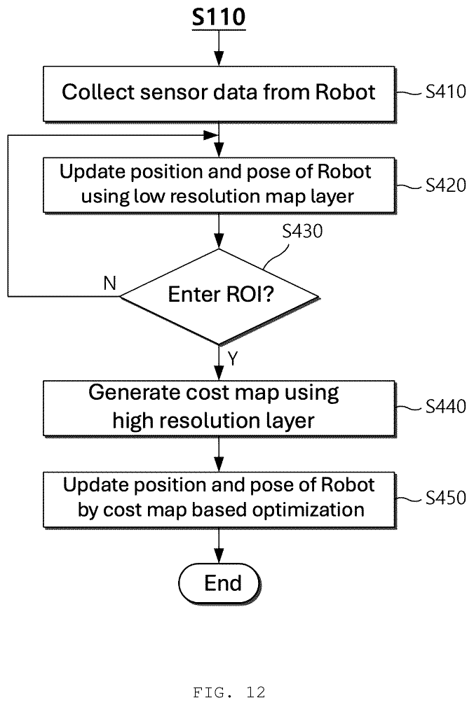

FIG. 11 is a diagram exemplarily illustrating KD-tree structured map data generated based on robot position in various embodiments.

In various embodiments, the computing device 100 may structure medium-resolution map layers and high-resolution map layers included within a predetermined range around the initial position of the robot 10 based on KD-Tree, as shown in FIG. 11. Through this, map layers corresponding to adjacent areas can be loaded more quickly based on the position of the robot 10.

In step S320, the computing device 100 may update the position of the robot 10 using a plurality of medium-resolution map layers based on the initial position of the robot 10 estimated through step S310 (fine position estimation through refinement).

In various embodiments, the computing device 100 may select two or more medium-resolution map layers included within a predetermined range around the initial position of the robot 10 from among the plurality of medium-resolution map layers based on the initial position of the robot 10 estimated using the low-resolution map layer, merge the selected two or more medium-resolution map layers, and perform secondary estimation of the position of the robot 10 using the merged two or more medium-resolution map layers.

Here, the predetermined range may be determined according to attributes of the robot 10.

For example, the size of the predetermined range may be determined in proportion to the speed of the robot 10.

As another example, the shape of the predetermined range may be determined based on the movement path, movement direction, and/or heading direction of the robot 10. For example, the predetermined range may have an elongated shape in a direction corresponding to the movement path of the robot 10.

In step S330, the computing device 100 may determine whether the robot 10 has entered a region of interest based on the position of the robot 10 updated based on the medium-resolution map layer through step S320.

In various embodiments, the computing device 100 may update the position of the robot 10 by merging medium-resolution map layers existing within a predetermined range around the initial position of the robot 10, and may continuously determine whether the robot 10 has entered a region of interest based on the updated position of the robot 10.

At this time, the computing device 100 may update the medium-resolution map layers included in the merged medium-resolution map layers based on the updated position of the robot 10.

More specifically, first, when the position of the robot 10 is estimated to be a first position, the computing device 100 may generate a medium-resolution map layer set by selecting and merging medium-resolution map layers included within a predetermined range around the first position, and may update the position of the robot 10 using the medium-resolution map layer set.

Thereafter, when the updated position of the robot 10 changes from the first position to a second position, the computing device 100 may update the medium-resolution map layer set based on the second position, and may update the position of the robot 10 again using the updated medium-resolution map layer set.

For example, the computing device 100 may select medium-resolution map layers included within a predetermined range around the second position, and may regenerate the medium-resolution map layer set with the selected medium-resolution map layers.

As another example, the computing device 100 may exclude from the medium-resolution map layer set a medium-resolution map layer that is outside the predetermined range around the second position among the medium-resolution map layers included in the medium-resolution map layer set. In addition, the computing device 100 may add to the medium-resolution map layer set a medium-resolution map layer that exists within the predetermined range around the second position but is not included in the medium-resolution map layer set among the medium-resolution map layers.

In step S340, when it is determined through step S330 that the robot 10 has entered a region of interest (or is predicted to enter a region of interest), the computing device 100 may update the position of the robot 10 using a high-resolution map layer corresponding to the region of interest (fine position re-estimation through re-performing refinement)

For example, when it is determined that the robot 10 has entered a specific region of interest within a predetermined space based on the position of the robot 10 updated based on the medium-resolution map layer, the computing device 100 may load a high-resolution map layer corresponding to the specific region of interest, and may update and estimate the position of the robot 10 using the loaded high-resolution map layer.

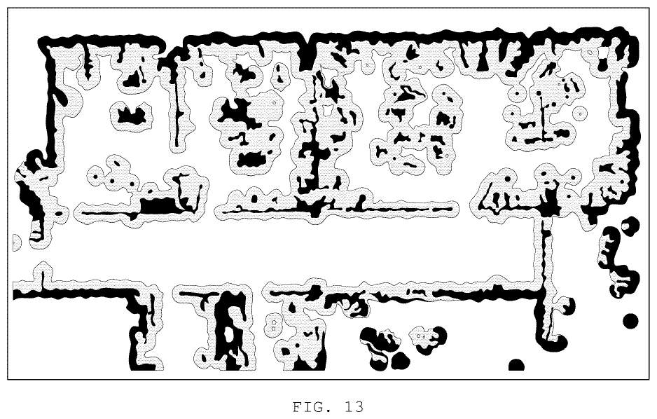

FIG. 12 is a flowchart of a robot position and pose precision estimation method using low-resolution maps and high-resolution maps in various embodiments.

Referring to FIG. 12, in step S410, the computing device 100 may acquire sensor data collected while the robot 10 travels through a predetermined space.

Here, the sensor data is data collected by scanning the predetermined space through sensors provided in the robot 10 that is disposed within the predetermined space and moves through the predetermined space. For example, the sensor data may be point cloud data collected through a LiDAR sensor included in the robot 10, but is not limited thereto.

In step S420, the computing device 100 may estimate and update the position and pose of the robot 10 using one low-resolution map layer based on the sensor data acquired through step S410.

In various embodiments, the computing device 100 may estimate the initial position and pose of the robot 10 based on a particle filter using the sensor data and one low-resolution map layer.

The 2D Localization algorithm uses a particle filter-based position estimation method. The particle filter assumes multiple particles (points) as the position of the robot, and calculates a cost representing accuracy by performing matching with sensor measurements based on the position of each particle. Thereafter, it is a method of estimating the optimal position based on this cost. This method is a simple yet intuitive approach that can work efficiently in various environments.

However, particle filters require several additional improvements. First, as the number of particles increases, there is an advantage of being able to test various cases for errors. However, as the number of particles increases, a problem occurs where the computational load increases linearly. This can cause performance degradation in application fields where real-time computation is important.

Second, since particle filters determine the optimal position based on discrete costs, if particles do not exist at the accurate ground truth position in specific situations, serious errors may occur. This can act as a major cause that significantly reduces the position estimation accuracy of robots, especially in complex environments. The present disclosure provides a method for simultaneously satisfying computational cost and accuracy.

More specifically, first, the computing device 100 may generate multiple particles within a predetermined space based on rough estimates of the initial position and pose of the robot 10.

Thereafter, the computing device 100 may map the sensor data acquired from the robot 10 at the position of each particle to calculate a cost as the degree of match between the sensor data and the low-resolution map layer, and may estimate the initial position and pose of the robot 10 based on the calculated cost.

Thereafter, the computing device 100 may update the position and pose of the robot 10 in real-time and/or at predetermined intervals using a particle filter based on sensor data acquired from the robot 10 in real-time and/or at predetermined intervals.

In various embodiments, the computing device 100 may structure high-resolution map layers included within a predetermined range around the position estimated based on the low-resolution map layer based on KD-Tree. Through this, high-resolution map layers corresponding to regions of interest that the robot 10 has entered can be loaded more quickly based on the position of the robot 10.

In step S430, the computing device 100 may determine whether the robot 10 has entered a region of interest based on the position of the robot 10 estimated based on the low-resolution map layer through step S420.

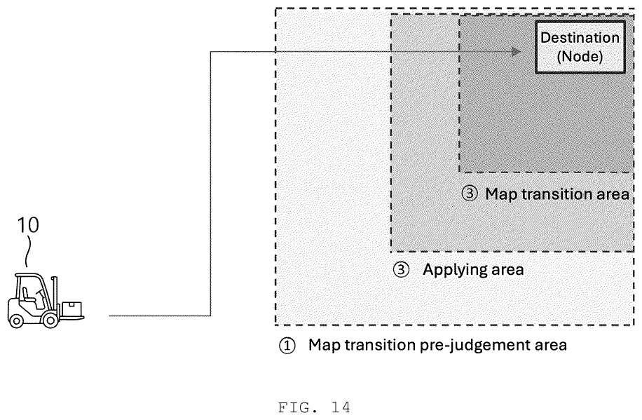

In step S440, when it is determined through step S430 that the robot 10 has entered a region of interest, the computing device 100 may generate a cost map using a high-resolution map layer corresponding to the region of interest. For example, when the high-resolution map layer is generated in the form of an occupancy grid map, the computing device 100 may generate a cost map by assigning cost values according to the presence or absence of obstacles to each of the plurality of grids included in the high-resolution map layer, as shown in FIG. 13, but is not limited thereto.

In step S450, the computing device 100 may estimate the current position and current pose of the robot 10 by performing position and pose optimization of the robot 10 based on the cost map generated through step S440.

More specifically, first, the computing device 100 may transform sensor data collected at a specific time based on the position and pose of the robot 10 estimated at the specific time.

In various embodiments, when the sensor data is point cloud data, the computing device 100 may transform the coordinates of each of the plurality of points included in the point cloud data into a map coordinate system corresponding to the cost map based on the position and pose of the robot 10 estimated at a specific time. For example, the sensor data may be transformed into a map coordinate system corresponding to the cost map based on Equation 2 below.

$${R}^{*} {m}_{i} + t \qquad Equation 2$$

Thereafter, the computing device 100 may calculate a cost value by matching the cost map generated based on the high-resolution map layer with the sensor data transformed based on the position and pose of the robot 10 estimated at a specific time. For example, the computing device 100 may match the cost map with points of the point cloud data, and may calculate the sum of costs of matched grids (hit grids) as the cost value. It is not limited thereto.

Thereafter, the computing device 100 may derive the optimized position and pose of the robot 10 by optimizing the position and pose of the robot 10 estimated at a specific time based on the cost value calculated through matching the cost map and sensor data, and may estimate the position and pose of the robot 10 at the specific time. For example, the computing device 100 may estimate the position and direction where the cost value calculated through matching the cost map and sensor data has a maximum value as the position and pose of the robot 10.

The position and pose estimation operation (step S450) of the robot 10 as described above may be repeatedly performed for every frame of sensor data from the time when the robot 10 enters the region of interest until it leaves the region of interest, but is not limited thereto.

The robot position and pose estimation method has been described with reference to the flowchart shown in the drawings. For simple explanation, the robot position and pose estimation method has been illustrated and described as a series of blocks, but the present disclosure is not limited to the order of the blocks, and some blocks may be performed in a different order from or simultaneously with what is shown and described in this specification. In addition, new blocks not described in this specification and drawings may be added, or some blocks may be performed in a deleted or changed state.

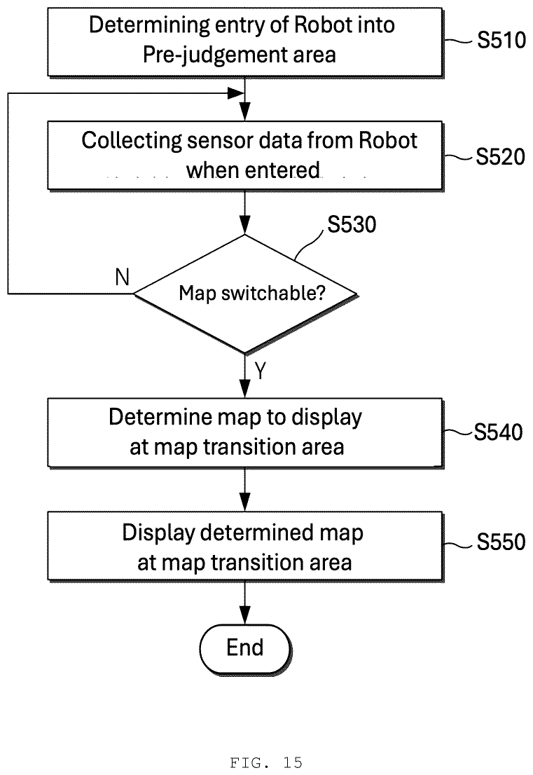

FIG. 14 is a diagram for explaining a method of distinguishing pre-judgment areas and map transition areas for switching maps with different resolutions in various embodiments.

In an environment operating hierarchical maps with different resolutions and utilization purposes, when maps are switched under specific conditions (for example, when switching from a first resolution to a second resolution), it is necessary to check whether map switching is possible.

In addition, according to embodiments of the present disclosure, it is necessary to ensure that when the processor switches maps, the switching is performed without delay and seamlessly.

For this purpose, in the map according to embodiments of the present disclosure, a pre-judgment area that allows an operation to check switchability to be triggered before switching the map transition area and the map can be separately set. The map transition area may be set according to the position and range of the destination (range of the station), and the work required at the destination (type of node or station). For example, if the work required at the destination is work that requires a wider activity area of the robot, the map transition area may be set wider.

As also described in the above-described embodiments of the present disclosure, places where high-resolution maps are displayed are either places where the robot's destination is located or places where accurate position and pose determination is necessary for the robot to perform specific operations.

Therefore, the pre-judgment area may be set as an area adjacent to the high-resolution display area including the destination designated for robot movement. In addition, as shown in FIG. 14, an application area may be included at a position closer to the high-resolution display area (map transition area) to enable flexible and smooth map switching.

In the application area, continuity may be maintained by applying weights to the map before transition and the map after transition. In addition, the processor may perform matching processing while using the map before transition in the application area. Alternatively, the processor may be configured to use both low-resolution maps and high-resolution maps simultaneously to compare processing results, and then use only one map when the matching rate increases.

If an autonomous vehicle is set to move toward a destination as shown in FIG. 14, at places far from the destination, a low-resolution map layer will be used to determine the vehicle's position for computational efficiency as described above.

When approaching the destination (for example, when entering the innermost rectangular area including the destination node in FIG. 14), a high-resolution map layer may be used as described above for more accurate position and pose estimation. In this case, the processor must switch the reference map for map display and position estimation from a low-resolution map to a high-resolution map. However, map switching may be difficult depending on the accuracy of current robot position estimation, whether surrounding environment recognition is possible, surrounding environment recognition accuracy, consistency between low-resolution maps and high-resolution maps, robot driving stability, illumination changes between the time of map generation and the current environment, and the matching rate between existing maps and current sensing data.

Therefore, in embodiments of the present disclosure, a map switching pre-judgment area is set before the robot enters an area where map switching should occur, so that map switching can be determined in advance or preprocessing necessary for smooth map switching can be performed.

The processor of the server that estimates the robot's position may determine whether there are problems with map switching using sensor data collected by the robot's sensors from the time the robot enters the pre-judgment area, and may perform determination of map switching feasibility and preprocessing for map switching while passing through the application area and map transition area. Through this, maps can be switched flexibly and smoothly.

The pre-judgment area may be a predetermined area according to the destination of robot travel, and may be an area automatically set to a certain size around the periphery of an area requiring high-resolution maps after the destination of robot travel is determined.

Meanwhile, the processor of the server that estimates the robot's position may place an application area between the pre-judgment area and the map transition area (or switch area) on the map to apply map switching (or map transition) in advance with preprocessed map data, thereby making map switching shown to users more smooth and flexible.

FIG. 15 is a flowchart of a method for displaying robot positions on maps with different resolutions according to conditions in various embodiments.

The processor or computing device of the server that estimates the robot's position may generate map data for a predetermined space as described above, and may estimate the position of the robot within the predetermined space based on the generated map data.

After estimating the robot's position, the processor may display the robot's position on a map according to the generated map data. Near the robot's destination (including areas requiring high-resolution maps such as where the robot must perform specific tasks in the middle), it is necessary to switch map display from low-resolution to high-resolution for such display.

Here, the generated map data includes a plurality of map layers having different attributes, and may have a hierarchical structure as the plurality of map layers are connected in a hierarchical manner based on attributes. In addition, the map data may include at least one low-resolution map layer corresponding to the predetermined space and one or more high-resolution map layers corresponding to one or more regions of interest set within the predetermined space. The generated map data may include a map switching pre-judgment area and a map transition area according to the robot's destination.

Meanwhile, the pre-judgment area may be determined based on the time required for processing sensor data collected from the robot and the robot's scheduled movement speed in the corresponding section. If the processing time is short or the robot's scheduled movement speed in the corresponding section is slow depending on the communication speed between the robot and server and the server's processing capability, the pre-judgment area may be set narrower. Conversely, if the processing time is long or the robot's movement speed is fast depending on the communication speed between the robot and server and the server's processing capability, the pre-judgment area may be set wider. The size of the pre-judgment area may also vary depending on the type and range of sensor data that must be collected for pre-judgment.

The step of displaying the robot's position may be performed by the processor according to the flowchart of FIG. 15.

First, the processor may determine whether the robot enters the map switching pre-judgment area (S510). When it is determined that the robot has entered the map switching pre-judgment area, the processor may collect sensor data collected by the robot while the robot moves to the map transition area (S520). Here, the type and range of sensor data that the processor must collect may be predetermined by the designer. For example, the data to be collected may be illumination of the current environment, data for determining stability of current driving, data for accuracy of surrounding environment recognition, data for accuracy of current position, illumination data at the time of map generation, and data for determining the matching rate between existing maps and current sensing data.

The processor may determine whether resolution switching of the map is possible based on the collected sensor data (S530). Meanwhile, the processor may determine the type of map to switch to in addition to whether the map can be switched. For example, the processor may determine the target resolution of the map to switch in the map transition area, and the type of map (global or local, indoor or outdoor, 3D or 2D, point cloud or camera).

The processor may determine switchability of map by determining whether a map targeted for switching can be matched with an existing map and displayed, and whether an accurate position can be displayed, when the robot enters the map transition area based on sensor data collected by the robot. For example, when the similarity between Wi-Fi fingerprint obtained at the destination and the current Wi-Fi fingerprint is 50% or higher, the robot's position is within 30 meters of the destination, and the root's moving direction is toward the destination at a speed of 0.5 m/sec or higher.

The switchability of map may be determined according to the accuracy of the robot's current position, whether there are surrounding environment recognition obstacles, consistency of the map, driving stability of the robot, illumination changes between the time of map generation and the current environment, and the matching rate between previously generated map data and sensor data collected by the robot.

The processor may determine the type of map to switch and display in the map transition area based on the switchability of map determined above (S540). For example, the processor may determine the resolution of the map to display after the robot enters the map transition area based on the switchability of map determined above. The processor may decide to display a high-resolution map if map switching is possible, or to display the previous low-resolution map if switching is not possible.

The processor may switch the map to the determined resolution after the robot enters the map transition area and display the robot's position on such map (S550).

Although embodiments of the present disclosure have been described above with reference to the attached drawings, those skilled in the art to which the present disclosure belongs will understand that the present disclosure may be implemented in other specific forms without changing its technical spirit or essential features. Therefore, the embodiments described above should be understood as illustrative in all respects and not restrictive.

What is claimed is:

1. A method performed by a computing device, the method comprising:
generating map data for a predetermined space; and
estimating a position of a robot within the predetermined space based on the generated map data,
wherein the generated map data includes a plurality of map layers having different attributes and has a hierarchical structure as the plurality of map layers are connected in a hierarchical manner based on attributes, and includes a low-resolution map layer corresponding to the predetermined space and one or more high-resolution map layers corresponding to one or more regions of interest set within the predetermined space,
wherein the estimating the position of the robot comprises:
estimating an initial position of the robot using the low-resolution map layer; and
when it is determined that the robot enters the one or more regions of interest based on the estimated position of the robot, updating the position of the robot using the one or more high-resolution map layers.

2. The method of claim 1, wherein the generating the map data comprises:
generating a low-resolution map layer having pixels of a first size;
generating one or more high-resolution map layers having pixels of a second size smaller than the first size; and
generating map data having a hierarchical structure by connecting the generated low-resolution map layer and the generated one or more high-resolution map layers in a hierarchical manner starting from map layers with larger sizes.

3. The method of claim 2, wherein the generating the low-resolution map layer comprises:
acquiring a plurality of sensor data collected while the robot travels through the predetermined space; and
generating a low-resolution map layer based on the acquired plurality of sensor data and collection positions of each of the acquired plurality of sensor data using Simultaneous Localization and Mapping (SLAM).

4. The method of claim 2, wherein the generated map data further includes a plurality of medium-resolution map layers,
wherein the estimating the position of the robot further comprises, after the estimating the position of the robot and before the updating the position of the robot, updating the position of the robot using the plurality of medium-resolution map layers based on the estimated initial position,
wherein the generating the map data further comprises generating a plurality of medium-resolution map layers having pixels of a third size, and
wherein the third size is smaller than the first size and larger than the second size.

5. The method of claim 4, wherein the generating the plurality of medium-resolution map layers comprises:
generating a plurality of grids by partitioning the predetermined space into grids of a predetermined size;
generating a plurality of medium-resolution map layers corresponding to each of the generated plurality of grids based on information recorded in the generated low-resolution map layer.

6. The method of claim 2, wherein the generating the one or more high-resolution map layers comprises:
setting one or more regions of interest within the predetermined space;
acquiring sensor data collected as the robot scans the set one or more regions of interest; and
generating one or more high-resolution map layers corresponding to the set one or more regions of interest based on the acquired sensor data.

7. The method of claim 4, wherein the updating the position of the robot using the plurality of medium-resolution map layers comprises:
selecting two or more medium-resolution map layers included within a predetermined range around the estimated initial position from among the plurality of medium-resolution map layers and merging the selected two or more medium-resolution map layers; and
updating the position of the robot using the merged two or more medium-resolution map layers.

8. The method of claim 7, wherein the merging the two or more medium-resolution map layers comprises:
updating medium-resolution map layers included in the merged two or more medium-resolution map layers based on the updated position of the robot.

9. The method of claim 4, wherein the estimating the position of the robot further comprises:
structuring medium-resolution map layers and high-resolution map layers included within a predetermined range around the estimated initial position based on KD-Tree.

10. A method performed by a computing device, the method comprising:
generating map data for a predetermined space; and
estimating a position of a robot within the predetermined space based on the generated map data,
wherein the generated map data includes a plurality of map layers having different attributes and has a hierarchical structure as the plurality of map layers are connected in a hierarchical manner based on attributes, and includes a low-resolution map layer corresponding to the predetermined space and one or more high-resolution map layers corresponding to one or more regions of interest set within the predetermined space,
wherein the estimating the position of the robot comprises:
estimating the position of the robot by matching the low-resolution map layer with sensor data obtained from the robot; and
when it is determined that the robot enters the one or more regions of interest based on the estimated position, updating the position of the robot by matching the one or more high-resolution map layers with sensor data obtained from the robot.

11. The method of claim 10, wherein the estimating the position of the robot within the predetermined space includes estimating a direction the robot is facing,
wherein the estimating the position of the robot by matching the sensor data includes estimating the direction the robot is facing, and
wherein the updating the position of the robot by matching the sensor data includes estimating the direction the robot is facing.

12. The method of claim 11, wherein the generating the map data comprises:
generating a low-resolution map layer having pixels of a predetermined size;
generating one or more high-resolution map layers having pixels of a size smaller than the predetermined size; and
generating map data having a hierarchical structure by connecting the generated low-resolution map layer and the generated one or more high-resolution map layers in a hierarchical manner starting from map layers with larger sizes.

13. The method of claim 10, wherein the estimating the position of the robot using matching of the one low-resolution map layer with sensor data obtained from the robot comprises:
obtaining sensor data from the robot at predetermined intervals; and
estimating the position of the robot based on a particle filter using the sensor data obtained at the predetermined intervals and the generated low-resolution map layer.

14. The method of claim 10, wherein the updating the position of the robot using matching of the one or more high-resolution map layers with sensor data obtained from the robot comprises:
generating a cost map using the generated one or more high-resolution map layers;
deriving an optimized position of the robot by optimizing the position of the robot based on the generated cost map; and
updating the position of the robot using the derived optimized position of the robot.

15. The method of claim 11, wherein the updating the position of the robot using matching of the one or more high-resolution map layers with sensor data obtained from the robot comprises:
deriving an optimized position of the robot for updating the position of the robot using Equation 1 below:
$${T}^{*} = {arg max}_{T} \sum f ( {R}^{*} {m}_{i} + t ) \qquad Equation 1$$
Here, T* is the optimized position and pose of the robot, R is the rotation transformation according to the initial pose of the robot, t is the translation transformation according to the initial position of the robot, mᵢ is a point included in the point cloud data collected from the robot, and ƒ( ) may be a cost calculation function according to the cost map.

16. A method performed by a computing device, comprising:
generating map data for a predetermined space;
estimating a position of a robot within the predetermined space based on the generated map data; and
displaying the position of the robot on a map according to the generated map data,
wherein the generated map data includes a plurality of map layers having different attributes and has a hierarchical structure as the plurality of map layers are connected in a hierarchical manner based on attributes, and includes at least a low-resolution map layer corresponding to the predetermined space and one or more high-resolution map layers corresponding to one or more regions of interest set within the predetermined space,
wherein the generated map data includes a map switching pre-judgment area and a map transition area according to the robot's destination,
wherein the step of displaying the position of the robot includes:
when the robot enters the map switching pre-judgment area, collecting sensor data collected by the robot while the robot moves to the map transition area after entering the map switching pre-judgment area;
determining whether resolution switching of the map is possible based on the collected sensor data; and
determining a display resolution of the map after the robot enters the map transition area based on the determination of whether resolution switching of the map is possible.

17. The method of claim 16, wherein the pre-judgment area is determined based on the time required for processing sensor data collected from the robot and the robot's scheduled movement speed in the corresponding section.

18. The method of claim 16, wherein whether resolution switching of the map is possible is determined according to the matching rate between the generated map data and the sensor data collected by the robot.

19. The method of claim 16, wherein the size of the map transition area is determined according to the type of work to be performed at the robot's destination.

20. The method of claim 16, wherein the estimating the position of the robot includes:
estimating the position of the robot using the low-resolution map layer; and
when it is determined that the robot enters the one or more regions of interest based on the estimated position of the robot, updating the position of the robot using the one or more high-resolution map layers.
